(19) United States
(12) Patent Application Publication
(10) Pub. No.: US 2004/0112513 A1
(43) Pub. Date: Jun. 17, 2004

(54) Process for manufacturing corrosion resistant metal products

(76) Inventor: Antonino Giorgio Cacace, West Glamorgan (GB)

Correspondence Address: YOUNG & THOMPSON, 745 SOUTH 23RD STREET 2ND FLOOR, ARLINGTON, VA, 22202

(21) Appl. No.: 10/472,434

(22) PCT Filed: Mar. 22, 2002
(86) PCT No.: PCT/GB02/01402

(30) Foreign Application Priority Data
Mar. 23, 2001 (GB) 0107315.4

(51) Int. Cl. B31F 1/00

(52) U.S. Cl. 156/221; 156/306.9; 156/307.7

(57) ABSTRACT

Methods (and products produced by the methods) are disclosed for sealing the cut end of a concrete reinforcing bar or other long product that comprises a core of mild steel or other corrosion susceptible metal and a cladding of stainless steel or other corrosion resistant metal bonded to an axially extending outer face of the core. The methods include the steps of providing a cap of corrosion resistant material, and shaped for mounting on the cut end of the long product with the exposed portion of the core enclosed by the cap. The cap has a skirt that overlies the cladding adjacent the cut end. A seal is formed in various ways between the skirt and the cladding. The seal may be formed by filling the space between the cut end and the cap with resinous sealant inserted in the cap before it is mounted over the cut end.

### FIELD OF THE INVENTION

This invention relates to a process for the manufacture of corrosion resistant metal products and to products produced from the process. The invention has particular but not necessarily exclusive application to products comprising a core formed from mild steel and having a stainless steel cladding. The term ‘clad products’ will be used herein to refer to such products. The present invention was conceived in the course of manufacturing such products in which the core is formed from recycled mild steel swarf but is not necessarily limited thereto. For example, the invention may also be applicable to products comprising a core formed from solid steel, powdered iron ore and even from other metals and metalliferous ores in which the problems identified herein are encountered.

Examples of such products, and processes for producing them, are described in the applicant's patent application #PCT/GB00/02894 and the several earlier patents referred to therein, the disclosures of all of which are incorporated herein by reference. It is therefore not considered necessary to described these products and processes in detail here.

The term “engineering steel” is intended to describe those low alloy steels that are commonly subjected to machining operations including mild steel (a term that itself includes carbon steel), forging steel and axle or shaft steel all of which contain significant amounts of carbon.

For brevity and where convenient, ‘stainless steel’ will be referred to herein as ‘ss’.

### BACKGROUND OF THE INVENTION

The background of the present invention is set out in detail in the specification of international patent application #PCT/GB94/00091. In the process described in that application, a billet comprised of an ss-jacket filled with briquettes of mild steel swarf is heated and worked into a finished product having the desirable properties and low cost of mild steel but that has an ss-cladding for substantially increased corrosion resistance.

In principle, the process is suitable for many traditional long products produced by conventional steel rolling techniques including plain and ribbed reinforcing bars (“rebars”) for concrete constructions, round bars, flat bars, angle bars and channel bars.

There is a market for a rebar having a 75-100 year life under severely corrosive conditions. However, the core of an ss-clad rebar is exposed when it is cut. Studies have shown that, if left exposed, these cut ends could reduce the life of the concrete structure.

The techniques used to date to seal the bar ends include arc welding the ends with ss-wire (e.g by the MIG or TIG process) and welding ss-end caps or -discs onto the bar ends. A major disadvantage of these is the cost and the availability of skilled personnel, especially if on site welding of the cut ends has to be effected. A double ss-weld layer procedure is required. Typically a single end is welded in 5-10 minutes. At a welder's rate of £10/hr and the cost of ss-welding wire at £0.75/end, the total cost/end=£2.0.

The ends could be welded robotically. However, the cost of a robotic welder is of the order of £100 000 and that of the welding wire would remain £0.75/end.

Due to the lengths of typical rebars, the welds are usually effected in the horizontal position. In combination with the thin ss-cladding this makes it difficult to effect a perfect weld. Currently 30% of all ends have to be rewelded due to pin holes. These are clearly evident once a bar has been pickled.

In another sealing technique, heat-shrinking plastics caps are mounted on the ends. Such caps do not form a water-tight seal and they are prone to be damaged or dislodged in a building site environment. A study has been carried out on a 12-year old concrete motorway in New Jersey (USA) constructed with ss-clad rebars with heat-shrunk plastic caps at the ends. The only corrosion evident in the rebars was inside the end-caps where the carbon steel core had corroded.

The applicant has made attempts to seal the bar ends by metal spraying. Metal spraying tends to be porous and has a brittle surface adherence. Porosity would lead to corrosion through the pores and therefore be ineffective. Furthermore metal sprayed ends would be prone to handling and on site damage.

Mild steel rebars have commonly been coated with an adhesive such as epoxy. The major weakness of such bars perceived by the market is that the epoxy coating is prone to sustaining damage during handling. Obviously the ends of ss-clad rebars would be equally prone to such damage, and this would therefore be perceived as a weakness by potential users.

### SUMMARY OF THE PRESENT INVENTION

In one aspect of the invention, there is provided a method of sealing a cut end of an elongate product comprising a core of corrosion susceptible metal and a cladding of corrosion resistant metal bonded to an axially extending outer face of the core, the method including the steps of providing a capping element that is of corrosion resistant metal and that is shaped so that the capping element can be mounted on the cut end of the product with an exposed portion of the core enclosed by the capping element and a skirt of the capping element overlying a portion of the cladding adjacent the exposed portion of the core, and causing a seal to be present between the skirt and the axially extending portion of the cladding.

It will be clear to the skilled addressee that, in this specification and the claims, the term “corrosion susceptible metal” means a metal that is liable to corrosion in the conditions of service in which the product is intended to be used and is clad with a cladding of metal that is less susceptible to corrosion in those conditions of service than the metal of which the core is composed. Similarly, it will be clear that the term “corrosion resistant metal” has the inverse meaning.

Advantageously, according to the invention, any space between the cut end and the capping element is filled by sealant.

In one form of the invention, liquid sealant is inserted in the capping element before the capping element is mounted over the cut end of the product. This form of sealant advantageously take the form of a suitable resin such as polyurethane. The volume of the liquid sealant so provided advantageously exceeds the volume of the space between the cut end and the capping element after the capping element is mounted over the cut end so that, according to the invention, the cut end of the product displaces some of the liquid sealant from the capping element when the capping element is mounted over the cut end.

One advantage of using a resinous sealant is that the sealant cures to become non-fluent. Another advantage is that many such sealants are able to form a stable bond to both the cladding and the capping element.

In one form of the invention, the capping element is deformed after it is mounted over the cut end of the product to cause the volume of any space enclosed by the capping element to be reduced. This helps to eliminate voids in the space between the cut end and the capping.

Again in one form of the invention, sealant in a non-liquid state is present in the capping element when the capping element is mounted over the cut end of the product, the seal being created by steps that include causing the sealant to become liquid so that it flows between the skirt and the axially extending portion of the cladding.

In one form of the invention, the sealant is caused to become liquid by steps that include applying heat to cause the sealant to melt so that it flows between the skirt and the axially extending portion of the cladding, and subsequently allowing the sealant to resolidify.

Advantageously, according to the invention the sealant is metallic. A suitable solder or brazing alloy may be used for such a sealant.

In one form of the invention, the heat is applied by an induction heating apparatus.

In an alternative form of the invention, the skirt is caused to be in sealing contact with the cladding by at least one process selected from the group comprising crimping, swaging, forging or welding.

In one form of the invention, the capping element is of corrosion resistant metal, advantageously stainless steel. In an alternative form of the invention, the capping element is of synthetic plastics material.

In an alternative form of the invention, the capping element is of a synthetic plastics material.

The scope of the invention extends to products formed by the methods claimed herein.

### BRIEF DESCRIPTION OF THE DRAWINGS

Various embodiments of the invention are now discussed with reference to the accompanying drawings in which:

FIG. 1 is a side view, partly in section, of a ribbed rebar with capping elements positioned adjacent its ends;

FIG. 2 is a similar view of the rebar with the capping elements mounted over its ends;

FIG. 3 is a schematic view showing the layout of a set of crimping dies disposed in an open position about a capping element;

FIG. 4 is a similar view of the crimping dies in a closed position;

FIG. 5 is a side view of an ss-clad round bar or flat bar with capping elements mounted on its ends;

FIG. 6 is a schematic view of an apparatus used to apply end caps containing metallic sealant to the ends of rebars;

FIG. 7 is a similar schematic view of an apparatus used to apply end caps that are welded to the ends of rebars; and

FIG. 8 is a view, similar to FIG. 2 or 5, of an ss-clad rebar, round bar or flat bar with capping elements welded on its ends

### DETAILED DESCRIPTION OF EMBODIMENTS OF THE INVENTION

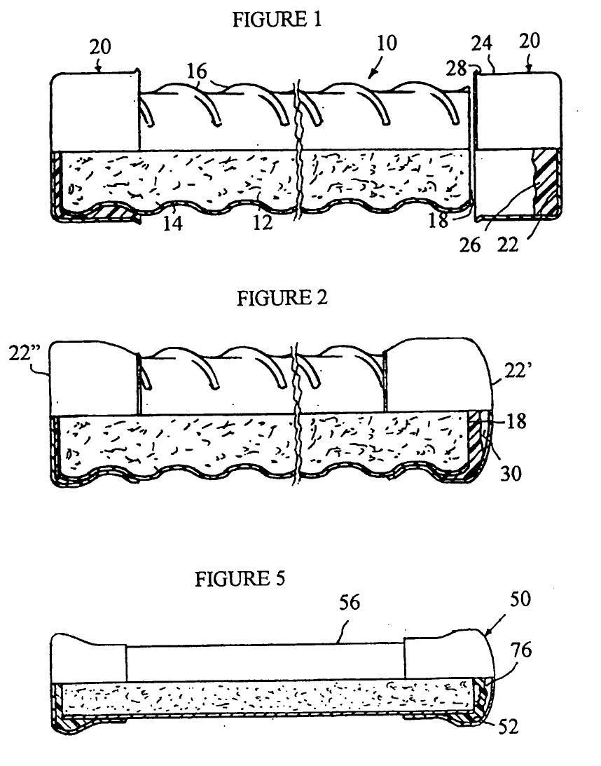

Referring to FIG. 1, a ribbed rebar 10 comprises a core 12 to which ss-cladding 14 is bonded. The ribs are shown at 16. The core is of mild steel or any other suitable grade of engineering steel. The cladding is of ASTM A316, A304 or any other suitable grade of stainless steel. In the present case, the rebar is produced by the process described in patent application #PCT/GB00/02894 and the earlier patents referred to therein. However, these are not essential conditions and, in principle, the invention may be applied to rebar and any other product of the type referred to herein produced by any other process and comprising a cladding of corrosion resistant metal bonded to a core of corrosion susceptible metal.

For the sake of illustration, the rebar 10 as shown is foreshortened. In practice the rebar will be much longer and will be cut to its designed length from parent stock of substantially greater length. At the cut end 13, a portion 18 of the core 12 is exposed at each end face. SS-clad bar of this kind is best cut to length by an abrasive cutter or other means that produce end faces that are square to the longitudinal axis of the bar. The cut ends are also desirably free of burrs and flashings. However, these goals are difficult to achieve economically or practically, especially where the cut is made on site. The method of the invention is nevertheless well suited to sealing the cut ends of clad products in such circumstances.

Capping elements 20 (hereinafter referred to simply as ‘caps’) are mounted over each cut bar end for this purpose. Each cap is cup shaped, having a circular base 22 integrally joined to a cylindrical skirt 24. In one embodiment, the cap is advantageously produced by deep drawing a disc stamped from a sheet of stainless steel of the same grade as the cladding. The cap may alternatively be of other suitable corrosion resistant metal, including another grade of stainless steel, that is compatible with whatever material the cladding is composed, particularly having regard to the avoidance of galvanic corrosion between the two metals when the rebar is in use.

In the example shown in FIGS. 1 and 2, a predetermined quantity of liquid resinous sealant, indicated schematically at 26, is inserted in the cap prior to mounting the cap on the bar end. Enough sealant should be inserted to ensure that, when the cap is mounted over the bar end, all of the space enclosed by the cap and not taken up by the bar end should be occupied by sealant. For this reason it will be necessary to insert an excess of sealant so that some of it is squeezed out by the bar end by the time it has been fully inserted into the skirt. A quantity of sealant equal to about 25% of the volume of the interior of the cap should be sufficient where the bar ends are reasonably square. More sealant, perhaps up to 50% of the same volume, may be required when the ends are cut at an angle or are jagged.

It is necessary that the skirt 24 must overlie the cladding completely when the bar end is fully inserted into the cap as shown at the left hand end of FIG. 1. The depth of the skirt must be chosen accordingly. In this position, the skirt 24 is crimped or swaged against the cladding as shown in FIG. 2, locking the two together and forming a seal that prevents the sealant when it is still liquid, from flowing out of the cap under gravity.

The term “crimping” refers to a process in which the skirt is squeezed tightly against the cladding without substantially deforming the cladding. On the other hand, in a “swaging” process, the applied force is sufficient to deform the cladding and perhaps more securely locking the cap on the bar. The term ‘swaging’ will hereinafter be used to cover both. In the swaging operation the skirt 24 is deformed inwardly. This tends also to cause some of the liquid sealant to be squeezed out. However, in the same process, the base 22 may become domed as shown at 22′ in FIG. 2. This may cause a void, indicated schematically as 30, between the cap and the bar end. Unless removed, the void may lead to corrosion of the exposed portion 18 of the core or crevice corrosion of the stainless steel. Voids can be removed by deforming the domed portion 22′ of the base inwardly while the sealant is still liquid. This can be achieved simply by striking the domed portion with the rounded head of a hammer. This is an important consideration when, as often happens, the rebar has been cut on site. The domed portion is thus at least partly flattened as shown schematically at 22″ or even domed inwardly, eliminating the void.

In due course the sealant cures, adhering to the surfaces of the cap and the bar end with which it is in contact and becoming non-fluent in the process. The sealant prevents corrosion of the exposed portion 18 of the core and the cap serves to protect the sealant and very effectively prolong it's life.

The sealant can be selected with regard to its suitability in the environment in which the end product is used. In the present instance, where the end product is a rebar for use in a concrete construction, the sealant is usefilly a high quality polyurethane having good adhesive properties and a long life. Suitable proprietary products, used for used for sealing roofs, are available under the Nurethane and Nuflex trade names and have a guaranteed life of 30 years when used for that purpose. Other organic materials, including certain flexible epoxies, may also be suitable. The sealant must be resistant to alkaline attack since freshly poured concrete has a high ph; it must also be resistant to high chloride attack from added salts during the life of the structure; and it must not deteriorate or debond with time as this would allow ingress of corrosive fluids to attack the core. Deterioration of the bond has been a problem with the epoxy coatings that have been applied to black rebar in the past.

As already noted, due to the typical length of rebars, it will most often be necessary to mount the caps on the bar ends when the rebar is horizontal and the cap is therefore turned sideways to the position shown in the drawings. Advantageously the sealant, when it is still in the liquid state should be sufficiently viscous to ensure that it does not flow out of the cap under gravity under these circumstances. The viscosity should also be such that, when the skirt of the cap is swaged and the base flattened, the sealant is caused to flow around the bar end rather than escape past the interface between the skirt and the cladding so that any voids tend to be eliminated.

In the present case, the nominal wall thickness of the cap is equal to 0.5 mm. However, the wall thickness can be chosen to suit the thickness of the cladding (that can also vary) as well as cost considerations. By way of example, the thickness of the cladding is typically about 0.5 mm for a 13 mm to 32 mm diameter rebar. For such rebars, a cap of between 0.5 mm to 1.0 mm wall thickness should be suitable for most purposes.

The depth and diameter of the cap is more dependent on the diameter of the rebar. The cap is advantageously loose fitting over the rebar so that it fits easily over the bar end. The free edge of the skirt may be flared as illustrated at 28. Furthermore, allowance should be made for burrs and flashes on the bar ends. However, for rebars up to at least 32 mm in diameter, if the diameter of the skirt is more than a certain amount greater than that of the rebar, the skirt is liable to deform non-uniformly when it is swaged. The cap may thus not be locked tightly on the bar end or may form an imperfect seal. There is thus a practical upper limit to the diameter of the skirt. The following table gives the sizes (in mm) of caps that have been found to be suitable for bars of the diameter shown:

| O/D of Rebar | I/D of Skirt | Depth of Skirt |
|---|---|---|
| 13-16 | 17.2 | 12 |
| 19-22 | 25.1 | 18 |
| 25-32 | 36.3 | 21 |

Clearly, suitable cap sizes can be selected for bars of any size.

Caps of the type described can be swaged on the bar ends by commercially available hydraulically operated machines that are commonly used for swaging end fittings on hydraulic hoses. A suitable such machine is sold under the Hydralok trade mark. FIG. 3 shows schematically eight swaging dies 38 arrayed as they are in a swaging machine of this type around the skirt 24 of a cap 20 located at the central axis 40 of the array.

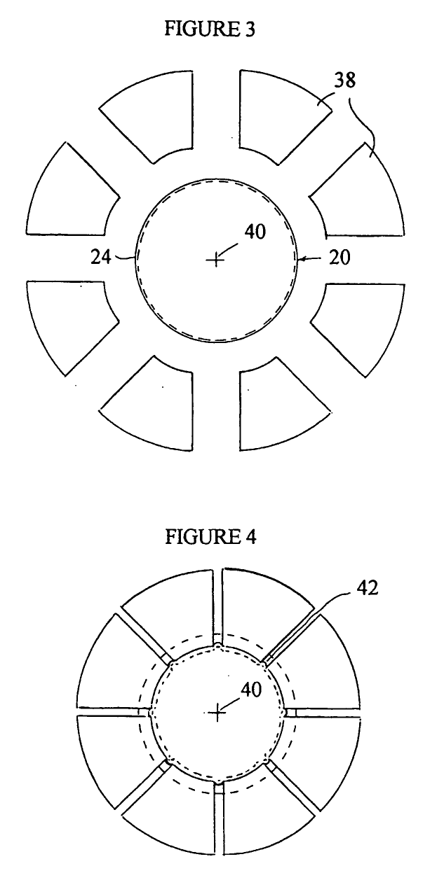

As shown in FIG. 4, the machine causes the dies to move radially inwardly towards the axis, deforming the skirt uniformly inwardly and forcing it against the outer face of the cladding on the rebar. Longitudinally extending ribs 42 are formed in the skirt in the process. Excess sealant is able to escape through these ribs. These machines are typically capable of applying up to 150 tonnes of force. This is sufficient to form an indent in the cladding, serving to lock the cap securely on the bar end.

Machines of this type are inexpensive. An important additional advantage is that they are already used not only in workshops but also on construction sites for joining rebars together. This is achieved by means of a steel sleeve into which the bar ends are inserted end to end, the machine being used to swage the sleeve to each bar end. In workshops, the swaging operation is frequently automated. However, on construction sites, it is more common to find manually operated swaging machines.

Sealing of rebar ends by this method is economical and quick. At the present time, for manually applying end caps to a batch of 120 cut ends of 16 mm diameter rebar, a typical total overall cost per end is of the order of £0.078, being made up of £0.013 for the ss-end cap, £0.019 for the cost of sealant and £0.046 labour cost at £5.50/hr. The labour cost is much reduced if the process is automated. At an average bar length of 4 m, the cost of sealing the ends of a tonne of 16 mm rebar would be about £25.

Tests have been carried out on the ends of ss-clad rebars sealed with end caps as described above. In these tests, the capped ends were immersed in an acid solution appropriate for stainless steel for 1-2 hours. This solution comprised 2.5% hydrofluoric and 12% nitric acid. The capped ends were then cyclically immersed an 8% saline solution and then dried over a period of 15 days. These tests were intended to replicate production conditions followed by expected service conditions. The capped ends were then sectioned in order to observe whether the core had been attacked by either the acid or the saline solution.

In some cases the domed ends of the caps were not flattened. Although voids were found in some of these, no attack or rust has been observed on any of the capped ends tested to date.

In an alternative method, a meltable metallic sealant is used instead of the organic sealant described above. Various metallic sealants are suitable, including:

low temperature melting solders that typically melt at 200-300° C. An example of a suitable corrosion resistant solder is P40 available from Johnson Matthey. This is composed of 96% Sn and 4% Ag;

silver brazing alloys that melt at 600-800° C. An example is Argobraze 56 or Argobraze 49H available from Johnson Matthey. The melting temperature of Argobraze 56 is 600-711° C. and the specification is 56% Ag, 27% Cu, 14.5% In, 2.55% Ni. Argobraze 56 is specially suited for stainless steel applications in wet conditions;

high temperature brazing alloys that melt at 800-1050° C. An example of a highly corrosion resistant such alloy is HTN2, also available from Johnson Matthey, and comprising 82.4% Ni, 7% Cr, 3.0% Fe, 3.1% Bo, 4.% Si.

The metallic sealant can be supplied in a cold form (including powder, pellet, wire or disc form) that is suitable for insertion in caps 50 that can be identical to the caps 20. A rebar 56 with a cap 50 mounted thereon is illustrated at the right hand end of FIG. 5, the metallic sealant being shown at 52.

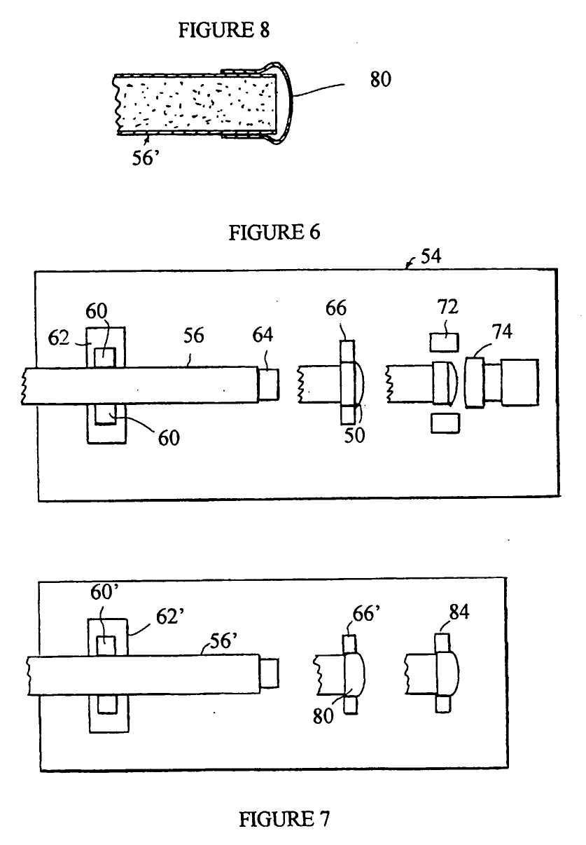

When metallic sealant is used, the entire capping and sealing process is advantageously at least partially automated. For this purpose an apparatus, shown schematically at 54 in FIG. 6 is used. In this apparatus, a bar 56 is manually or automatically moved to a predetermined position between a pair of hydraulically operated jaws 60 mounted in a transport carriage 62 with the bar end against a locating stop 64. This ensures that the bar end is positioned at the correct axial distance from, and in axial alignment with, a swaging head 66 equipped with a set of swaging dies similar to those shown in FIGS. 3 and 4. The jaws 60 are then operated to grip the bar and the stop is withdrawn laterally, allowing access to the bar end. A suitable flux is applied to the bar end before a cap 50, with the correct quantity of cold metallic sealant inserted, is manually mounted over the bar end. The transport carriage is then operated to advance the bar in the axial direction so that the bar end, carrying the cap 50, enters the swaging head 66. The swaging dies are operated to swage the skirt of the cap to the cladding of the bar.

The transport head is now again operated to advance the bar 56 further, this time to a position in which the bar end, carrying the swaged cap, enters the coil 72 of a conventional induction heating apparatus. This allows the sealant to be heated to melting point is a matter of seconds. The molten sealant is fluent and migrates to the interface between the skirt and the cladding. At the same time, a dome shaped head 74 is advanced axially towards the bar end. The head 74 bears on the domed base of the cap, flattening it to remove voids 76 in the space between the bar end and the cap.

A seal is formed at the interface when the sealant cools and solidifies. The transport head withdraws the rebar and releases it, thereby allowing the rebar to be manually removed from the apparatus 54. Because the cap is firmly locked on the rebar, it is not necessary to wait for the sealant to solidify.

Many proprietary fluxes are available. Examples are Tenacity 5 and Mattiflux 100 available from Johnson Matthey . Alternatively, ammonium chloride either alone or mixed with aluminium, both in powder form, may be used as fluxes. An advantage of the latter is a reduced possibility of the occurrence of inclusions produced by the flux when it melts.

Using a metallic sealant is likely to be more expensive and more difficult to apply in the field than an organic sealant.

Only in powder form is the raw metallic sealant to some extent fluent before it is heated. Even in powder form, the cold sealant does not flow as readily as liquid sealant. Consequently, voids 76 are to be expected after the skirt is swaged. However, provided that the end face of the bar is reasonably square, such voids are removed when the domed end of the cap is flattened as described above and illustrated at the left hand end of the rebar in FIG. 5. If the end face is ragged or not sufficiently square, it may be necessary to increase the amount of raw sealant that is inserted in the cap and, as a consequence, to provide a cap with increased depth.

If a cap with metallic sealant is applied to the cut end of a rebar on site, the cap can be swaged by a hand operated machine as described above, and the sealant heated to melting point by an oxy-acetylene or other suitable gas heating equipment. Such equipment is readily available and, in any case, is used on nearly all construction sites. As before, the domed end of the cap can be flattened by striking it with a hammer.

In another embodiment, the cap 20 is of a synthetic plastics material. Examples of suitable such plastics materials are polyurethane and PVC but there are others. With certain modifications, discussed below, the foregoing description of a metal cap is equally applicable to a plastics cap. Furthermore, the method of applying plastics caps is substantially identical to the described method of applying metallic caps using resinous sealant and need not be repeated here. Also, the same type of resinous sealants as already described may be used with plastics caps.

Before being fitted, the metallic cap is a loose fit over the end of the rebar. Unlike this, it is of advantage that the skirt of the plastics cap is a tight fit over the rebar end so that it must undergo a certain degree of elastic expansion as it is being fitted. This ensures that the cap grips the end of the bar firmly until the sealant cures. One advantage of the use of a plastics cap is that any ribs on the bar actually assist the cap to grip the bar. It is not necessary to strike the plastics cap, at least not with any substantial force or to deform it to any substantial degree. It is only necessary to apply sufficient force to push the cap into place on the end of the bar and in this process it deforms only to the extent that the skirt expands outwardly to fit over the bar. Another advantage of using a plastics cap with resinous sealant is that it is easy to apply on site.

A ribbed bar of 16 mm nominal diameter has an overall diameter across the ribs of 18 mm. The skirt of a plastics cap of polyurethane material for fitting to this bar has an internal diameter of 17.1 mm and a wall thickness of 1.5 mm. Clearly, these sizes would vary to suit the size of the bar and the material of which the cap is made.

The methods of sealing the bar ends have various advantages in addition to those mentioned:

They are inexpensive. A few pence cost per bar end translates into a considerable cost per tonne and could edge the cost of clad rebar towards that of solid ss-rebar. Typically for 4 m lengths of 16 mm rebar there are 320 ends per ton.

The caps are quick and simple to apply. In a production situation the process is easy to automate. On site, the process can be carried out by non-skilled personnel.

The caps cannot be easily damaged or removed. This is so whether due to handling during transportation or on site, during fitting and installation in the structure; or during casting and vibrating concrete.

It is expected that the end seals will have the same useful life as ss-clad rebar.

Yet another method of sealing the ss-clad rebars is described with reference to FIGS. 7 and 8. In this method, no sealant is used. Apparatus is used that has many components whose construction and function is similar to equivalent components in the apparatus shown in FIG. 6. Such components are identified in both Figures by the same numbers, those in FIG. 7 having a dash (′) appended.

In FIG. 7, end caps 80 are provided that, again, can be identical to the end caps 20, 50. As before, a cap 80 is mounted over the cut end of a ss-clad rebar 56′ gripped by a pair of jaws 60′ mounted on a carriage 62′ and in axial alignment with a swaging head 66′. The rebar is advanced by the carriage 62′ to the swaging head 66′ that is then operated to swage the skirt of the cap to the cladding of the rebar. The rebar is now moved to a position in which the bar end, carrying the swaged cap, enters the head of a conventional spot or forge welding apparatus 84. (In a “forging” process, the skirt and the cladding are heated and are, as a result, bonded or welded together homogeneously where the force is applied). The apparatus 84 is operated to weld the skirt to the cladding along a line extending around the entire circumference of the rebar, forming a seal at the interface.

This method requires no sealant and would be easily automated. It is possible that the swaging and welding operation could be carried out in a single operation by an integrated swaging/welding head. However, the method has some disadvantages. It may not be possible to used it for ribbed rebar. The welding apparatus is expensive and would not usually be found on a construction site. So, in a practical sense, the method is not suitable for site work. Also, it may be difficult to weld the caps that are of thin material to the relatively massive rebar.

It is not intended that recognised mechanical equivalents of and/or modifications of and/or improvements to any matter described and/or illustrated herein should be excluded from the scope of a patent granted in pursuance of any application of which this specification forms a part or that claims the priority thereof or that the scope of any such patent should be limited by such matter further than is necessary to distinguish the invention from the prior art.

1. A method of sealing a cut end [13] of an elongate product [10, 56] comprising a core [12] of corrosion susceptible metal and a cladding [14] of corrosion resistant metal bonded to an axially extending outer face of the core, the method being CHARACTERISED IN including the steps of providing a capping element [20, 50, 80] that is of corrosion resistant material and that is shaped so that the capping element can be mounted on the cut end of the product with an exposed portion [18] of the core enclosed by the capping element and a skirt [24] of the capping element overlying a portion of the cladding adjacent the exposed portion of the core, and causing a seal to be present between the skirt and the axially extending portion of the cladding.

2. A method according to claim 1, CHARACTERISED IN THAT any space between the cut end and the capping element is filled by sealant 26, 52].

3. A method according to claim 2 CHARACTERISED IN THAT liquid sealant [26] is inserted in the capping element before the capping element is mounted over the cut end of the product.

4. A method according to claim 3, CHARACTERISED IN THAT the liquid sealant is a resin that sets to become solid.

5. A method according to claim 3 or claim 4, CHARACTERISED IN THAT the volume of the liquid sealant inserted in the capping element exceeds the volume of the space between the cut end and the capping element and some of the liquid sealant is displaced by the cut end when the capping element is mounted over the cut end.

6. A method according to any one of claims 3 to 5, CHARACTERISED IN THAT the capping element is deformed [22″] after it is mounted over the cut end of the product to cause the volume of any space enclosed by the capping element to be reduced.

7. A method according to claim 2, CHARACTERISED IN THAT sealant [52] in a non-liquid state is present in the capping element when the capping element [50] is mounted over the cut end of the product, the seal being created by steps that include causing the sealant to become liquid so that it flows between the skirt and the axially extending portion of the cladding.

8. A method according to claim 7, CHARACTERISED IN including the steps of applying heat to cause the sealant to melt so that it flows between the skirt and the axially extending portion of the cladding, and subsequently allowing the sealant to resolidify.

9. A method according to claim 8, CHARACTERISED IN THAT the sealant is metallic.

10. A method according to claim 9, CHARACTERISED IN THAT the heat is applied by an induction heating apparatus [72].

11. A method according to claim 1, CHARACTERISED IN THAT the skirt of the capping element [80] is caused to be in sealing contact with the cladding by at least one process selected from the group comprising crimping, swaging, forging or welding.

12. A method according to any one of claims 1 to 11, in which the core is of engineering steel and the cladding is of stainless steel.

13. A method according to any one of claims 1 to 2, in which the capping element is of corrosion resistant metal.

14. A method according to claim 13, in which the capping element is of stainless steel.

15. A method according to any one of claims 1 to 5, in which the capping element is of a synthetic plastics material.

16. An elongate product produced by a method as claimed in any one of claims 1 to 15.
